(19) United States
(12) Patent Application Publication
(10) Pub. No.: US 2010/0005145 A1
(43) Pub. Date: Jan. 7, 2010

(54) CONFIGURABLE E-MAIL REGIONS THAT ALLOW RECIPIENT READ PERMISSIONS

(75) Inventors: Jason J. Jaramillo, Austin, TX (US); Jacob J. Rosales, Austin, TX (US); Luis A. Garcia, Austin, TX (US); Jorge A. Rasillo, Round Rock, TX (US)

Correspondence Address: IBM CORPORATION (ACCSP);c/o Suiter Swantz pc llo, 14301 FNB Parkway, Suite 220, Omaha, NE, 68154, US

(73) Assignee: INTERNATIONAL BUSINESS MACHINES CORPORATION, Armonk, NY (US)

(21) Appl. No.: 12/166,869

(22) Filed: Jul. 2, 2008

(51) Int. Cl. G06F 15/16

(52) U.S. Cl. 709/206

(57) ABSTRACT

The present disclosure is directed to a method for reconfiguring message permissions based upon a recipient. The method may receive a message. Then, the method may allow the user to set a read permission associated with a region in the message that may allow the region to be displayed only to specified recipients. This method may allow a user to save time by creating only one message that contains different content that is intended for different recipients to view.

### TECHNICAL FIELD

The present disclosure generally relates to the field of computer programming, and more particularly to a method for allowing a user to selectively identify which recipients get to view different regions of a message body.

### BACKGROUND

A user may have to create and send multiple messages regarding a similar topic to multiple recipients. However, writing and re-writing multiple messages regarding a similar topic and transmitting these messages to multiple recipients can be time consuming and inefficient.

### SUMMARY

The present disclosure is directed to a method for reconfiguring message permissions based upon a recipient. The method may receive a message. Then, the method may allow the user to set a read permission associated with a region in the message that may allow the particular region to be displayed only to specified recipients. This method may allow a user to save time by creating only one message that contains different content that is intended for different recipients to view.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 is a flow diagram of the method for reconfiguring message permissions based upon a recipient.

### DETAILED DESCRIPTION

Reference will now be made in detail to the subject matter disclosed, which is illustrated in the accompanying drawings.

The present disclosure is directed to a method for reconfiguring message permissions based upon a recipient. The method may receive a message, and then the method may receive a user selection of a read permission associated with a region in the message that may allow the region to be displayed only to specified recipients. This method may allow a user to save time by creating only one message that contains different content for different recipients.

Within a message, a user may create different regions of the message body that contain message content. For each recipient of the message, the user may set the read permissions for each region. This may allow each recipient to only view parts of the message that are intended for that recipient.

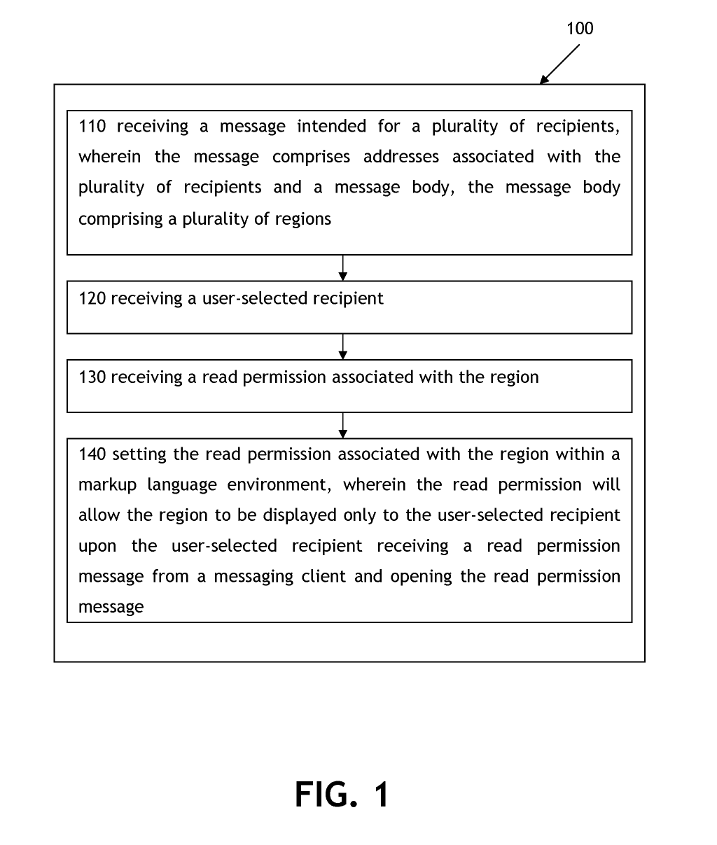

Referring to FIG. 1, a flow diagram of a method 100 for reconfiguring message permissions based upon a recipient is depicted. Method 100 may receive a message intended for a plurality of recipients, wherein the message may comprise message addresses associated with the plurality of recipients and a message body, the message body may comprise a plurality of regions 110. The method 100 may receive a user-selected recipient 120. Then, the method 100 may receive a read permission associated with the region 130. Next, the method may 100 set the read permission associated with the region within a markup language environment 140. Setting the read permission 140 may allow the region to be displayed only to the user-selected recipient 120 upon the user-selected recipient 120 receiving a read permission message from a message client and opening the read permission message.

One embodiment of the present disclosure may allow a user to set a read permission (hereinafter permission region(s)) using a standard markup language that may specify the recipients that are allowed to view the permission region. Using a standard markup language may allow the user to specify permission regions through command line interfaces such as UNIX, AIX, i5OS, and the like.

Another embodiment of the present disclosure may allow a user to set permission regions using a standard markup language such as XML, which may allow the user to set permission regions in alternate messaging venues. For example, a user may set permission regions of a message that are transmitted with Hypertext Transfer Protocol (HTTP) web pages, Internet Relay Chat (IRC), and the like.

Another embodiment of the present disclosure may allow a user to set the permission regions on a client side within a client-server relationship. Allowing the user to set permission regions on the client side may allow for increased message security and integrity.

Another embodiment of the present disclosure may allow a user to select the permission regions using selections within a selection device and specifying intended users from a menu. Default sections may be the complete message, and default users with permissions may be all of the users listed as recipients in any of the fields.

In the present disclosure, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

1. A method for reconfiguring message permissions based upon a recipient, the method comprising:
receiving a message intended for a plurality of recipients, wherein the message comprises message addresses associated with the plurality of recipients and an message body, the message body comprising a plurality of regions;
receiving a user-selected recipient;
receiving a read permission associated with a region; and
setting the read permission associated with the region within a markup language environment on a client side within a client-server relationship, wherein the read permission will allow the region to be displayed only to the user-selected recipient associated with the region upon the user-selected recipient associated with the region receiving a read permission message from a messaging client and opening the read permission message.
